(19) United States
(12) Patent Application Publication
(10) Pub. No.: US 2009/0300934 A1
(43) Pub. Date: Dec. 10, 2009

(54) SHOE DRYING FRAME

(76) Inventors: Yuri A. Hesse, Ocala, FL (US); Claudia L. Hesse, Ocala, FL (US)

Correspondence Address: EDWARD M. LIVINGSTON, PA, 963 TRAIL TERRACE DRIVE, NAPLES, FL, 34103, US

(21) Appl. No.: 12/136,083

(22) Filed: Jun. 10, 2008

(51) Int. Cl. F26B 25/00; F26B 25/06

(52) U.S. Cl. 34/106; 34/104; 34/239

(57) ABSTRACT

A shoe drying frame (1) having a securing means, such as magnets (8), located on an underside (9) of the frame and at least one strap (6), which is preferably elastic, attached to a first and second side wall (2) and (3)of the frame so as to hold at least one athletic shoe (11) within the frame (1). At least one adjustable strap (6) may be located on the first and second side walls (2) and (3) of the frame so as to accommodate athletic shoes (11) of a greater height. To use the present invention, a user first positions the shoe drying frame (1) against a dryer drum (14) such that the magnets are adjacent to the dryer drum (14). Then, the user places at least one athletic shoe (11) within the perimeter of frame (1) such that the sole of the athletic shoe (12) is adjacent to the dryer drum (14) and positions the toe of the athletic shoe (11) underneath the straps. If adjustable straps (6) are used, then the user tightens the adjustable straps (6) as needed so as to securely hold the athletic shoe (11) against the dryer drum (14), thereby eliminating the noise typically associated with drying athletic shoes (11) in a conventional dryer.

### BACKGROUND OF THE INVENTION

This invention relates to drying shoes in a conventional dryer, more particularly, a shoe drying frame that permits shoes to be dried in a dryer quietly and without damaging the dryer.

Although there are numerous brands and types of athletic shoes, such as tennis shoes, walking shoes, running shoes and so forth available, the cost of such shoes, as a whole, has drastically increased over recent years. Even though great strides have been made to increase the durability, and thus life, of athletic shoes, many people discard the athletic shoes once they become dirty, regardless of whether the shoes themselves are still in good condition, due to the many difficulties associated with drying the shoes.

Many athletic shoes may be washed in a conventional washing machine. However, once the shoes are clean, it takes a long period of time in which to air dry the shoes, thereby discouraging individuals from washing the shoes at all. In addition, although drying the shoes in a conventional dryer would expedite the drying of the shoes, many people are reluctant to do so due to the constant banging sound created by the shoes hitting the dryer drum. Moreover, many people are concerned that the constant banging of the shoes to the dryer drum will cause damage to the dryer. Finally, individuals are hesitant to dry shoes in a dryer with clothing for fear of stretching, marking or otherwise damaging the clothing. However, for both financial and environmental reasons, many people do not like to operate a dryer unless it is full, thereby once again discouraging individuals from washing and drying athletic shoes.

Thus, a need exists for a shoe drying frame that permits individuals to quietly dry athletic shoes in a conventional dryer without damaging the dryer and while at the same time drying clothing.

The relevant prior art includes the following references:

| U.S. Pat. No. | | |
|---|---|---|
| (U.S. unless stated otherwise) | Inventor | Issue/Publication Date |
| 4,702,016 | Grigsby et al. | Oct. 27, 1987 |
| 5,623,769 | Hayden | Apr. 29, 1997 |
| 6,374,509 | Jackson, Sr. et al. | Apr. 23, 2004 |
| 5,220,734 | Carver | Jun. 22, 1993 |
| 5,080,312 | Ebey | Jan. 14, 1992 |
| 5,024,408 | Magee | Jun. 18, 1991 |
| 6,543,630 | Hope | Apr. 08, 2003 |
| 4,109,397 | Daily | Aug. 29, 1978 |

### SUMMARY OF THE INVENTION

The primary object of the present invention is to provide a shoe drying frame for drying shoes in a dryer that holds the shoes, thereby preventing banging of the shoes against the dryer drum.

A further object of the present invention is to provide a shoe drying frame that is easy to use.

An even further object of the present invention is to provide a shoe drying frame that permits an individual to dry shoes and clothing at the same time without damaging the clothing.

The present invention fulfills the above and other objects by providing a shoe drying frame having a securing means, such as magnets, located on an underside of the frame and at least one strap, which is preferably elastic, attached to a first and second side wall of the frame so as to hold at least one athletic shoe within the frame. At least one adjustable strap may be located on the first and second side walls of the frame so as to accommodate athletic shoes of a greater height.

To use the present invention, a user first positions the shoe drying frame against a drum of a dryer such that the magnets are adjacent to the drum of the dryer. Then, the user places at least one athletic shoe within the perimeter of frame such that the sole of the athletic shoe is adjacent to the drum of the dryer and positions the toe of the athletic shoe underneath the straps. If adjustable straps are used, then the user tightens the adjustable straps as needed so as to securely hold the athletic shoe against the dryer drum, thereby eliminating the noise typically associated with drying athletic shoes in a conventional dryer.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a top view of a shoe drying frame of the present invention in use;

FIG. 2 is a side view of the shoe drying frame of the present invention;

FIG. 3 is a cross-sectional view along line 3-3 of the embodiment of FIG. 1;

FIG. 4 is a top view of an alternate embodiment of the shoe drying frame of the present invention having removable straps;

FIG. 5 is an underside view of a shoe drying frame of the present invention; and

FIG. 6 is a side view of the shoe drying frame of the present invention attached to a drum of a dryer.

### DESCRIPTION OF THE PREFERRED EMBODIMENTS

For purposes of describing the preferred embodiment, the terminology used in reference to the numbered components in the drawings is as follows:

1. shoe drying frame, generally

2. shoe drying frame first side wall

3. shoe drying frame second side wall

3. shoe drying frame front wall

5. shoe drying frame rear wall

6. strap

7. shoe drying frame underside

8. magnet

9. shoe drying frame underside

11. athletic shoe

10. shoe drying frame face side

12. athletic shoe sole

13. shoe drying frame opening

14. dryer drum

15. strap first end

16. strap second end

17. adjustable strap

18. removable strap

19. means for removable connection

20. adjustment buckle

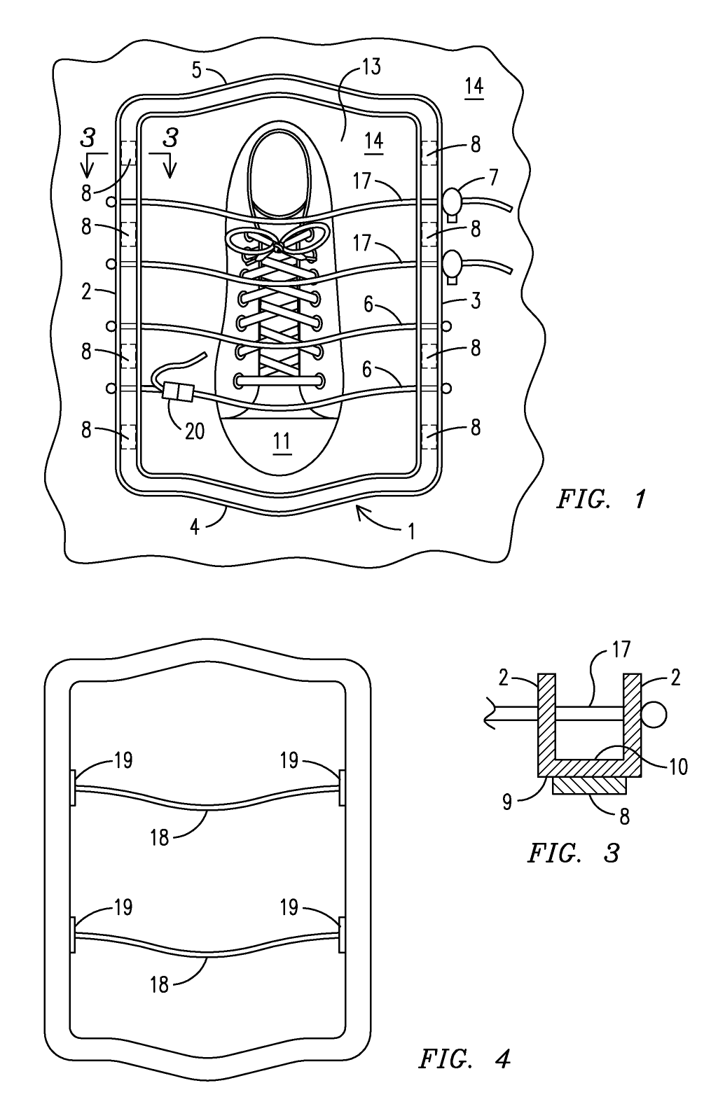

With reference to FIG. 1, a top view of a shoe drying frame of the present invention in use is shown. The shoe drying frame 1 includes a first side wall 2 and an opposing second side wall 3, a front wall 4 and a rear wall 5 which join together to form a centrally-located shoe drying frame opening 13 sized for the acceptance of at least one athletic shoe 11. At least one strap 6 extends across the shoe drying frame opening 13 and at least one magnet 8 is located on the shoe drying frame 1 so as to hold the shoe drying frame 1 against the dryer drum 14. The at least one strap 6, which is preferably elastic, is secured to the shoe drying frame side walls 2 and 3 so as to retain at least one athletic shoe 11 within the shoe drying frame opening 13 when the shoe drying frame 1 is secured to a dryer drum 14. An adjusting means 7, which is preferably a clip, may be used in conjunction with an adjustable strap 17 so as to permit the straps 6 to be extended or retracted, thereby accommodating athletic shoes 11 of various sizes. In addition, an adjustment buckle 20 may also be used so as to shorten or lengthen the amount of strap 6 extending across the shoe drying frame opening 13, thereby accommodating athletic shoe(s) 11 of various sizes.

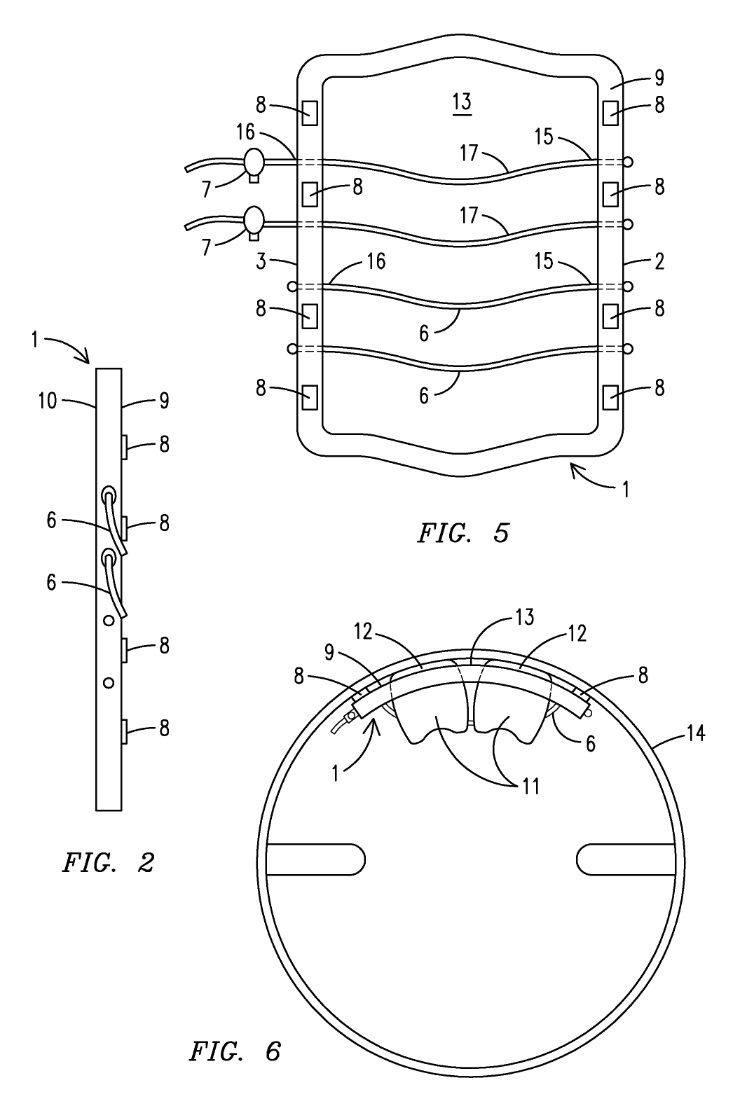

In FIG. 2, a side view of the shoe drying frame of the present invention is shown. The shoe drying frame 1 has a shoe drying frame face side 10 and an opposing shoe drying frame underside 9. At least one securing means, such as a magnet 8, is located on the shoe frame underside 9 so as to permit a user to secure the shoe drying frame 1 to a dryer drum 14.

Next, FIG. 3 shows a cross-sectional view along line 3-3 of the embodiment of FIG. 1. The shoe drying frame 1, including the shoe drying side walls 2, shoe drying frame front wall 4 and shoe drying frame rear wall 5, is preferably U-shaped so as to reduce the amount of space required when using the shoe drying frame 1; however, the walls 2, 3, 4 and 5 may be of any other shape in cross-section, including circular and square, and may be hollow or solid.

Next, FIG. 4 shows a top view of an alternate embodiment of the shoe drying frame of the present invention having removable straps. In this embodiment, the shoe drying frame 1 utilizes at least one removable strap 19 that extends across the shoe drying frame opening 13 and is removably securable to the shoe drying frame first and second side walls 2 and 3. The means for removably connecting 19 the removable straps 18 may include hook and loop type fastening means, hooks or any other means.

In FIG. 5, an underside view of a shoe drying frame of the present invention is shown. A means for securing the shoe drying frame 1 to a dryer drum 14 is located on the shoe drying frame underside 9 and may be at least one magnet 8, but is preferably a plurality of magnets 8, so as to retain the shoe drying frame 1 against the dryer drum 14. The straps 6, which extend across the shoe drying frame opening 13 by securing a strap first end 15 to the shoe drying frame first wall 2 and a strap second end 16 to the shoe drying frame second wall 3, retain the athletic shoe 11 within the confines of the shoe drying frame 1 and against the dryer drum 13. An alternate means for securing the adjustable straps 17 to the shoe drying frame side walls 2 and 3, is by securing the strap first end 15 to the first side wall 2 and extending the strap second end 16 through the second side wall 3 and utilizing an adjusting means 7, preferably a clip that slides along the strap 17 and is adjacent to the second side wall 3 when in use, that permits a person to extend or retract the length of the strap 17 across the shoe drying frame opening 13, thereby allowing for the accommodation of athletic shoes 11 of various sizes.

Finally, FIG. 6 shows a side view of the shoe drying frame of the present invention attached to a drum of a dryer. At least one athletic shoe 11 may be used in conjunction with the shoe drying frame 1 of the present invention; however, the shoe drying frame 1 may also accommodate more than one athletic shoes 11 as well. To use the present invention, a user first secures the shoe drying frame 1 against a dryer drum 14 via a securing means, which is preferably a plurality of magnets 8 located on the shoe drying frame underside 9. Then, the user positions the athletic shoe(s) 11 within the shoe drying frame opening 13 such that the athletic shoe sole 12 is adjacent to the dryer drum 14 and the straps 6 overlap the athletic shoe(s) 11. If adjustable straps 17 are used, the user then tightens the straps 17 by sliding the adjusting means 7 along the length of the strap 17 such that the adjusting means 7 is adjacent to the shoe drying frame second wall 3 (not shown). Finally, the user may add clothes to the dryer and activate the dryer to commence drying the shoes.

Because the athletic shoe(s) 11 are effectively strapped within the shoe drying frame 1, the shoes will not bang against the dryer drum 14. In addition, because the athletic shoe soles 12 are positioned directly against the dryer drum 14 during use, a person may add clothes to a drying cycle in order to conserve energy. Finally, various embodiments of the present invention include a shoe drying frame 1 having straps 6 secured to both side walls 2 and 3; having an adjustable strap 17 wherein the strap first end 15 secured to a first side wall 2 and a strap second end 16 that is unsecured and utilizing an adjusting means 7; adjustable straps 17 having both strap ends 15 and 16 unsecured and utilizing an adjusting means 7; and the inclusion of removable straps 18.

The use of the present invention will allow a person to quickly, easily and quietly dry athletic shoes in a conventional dryer.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

Having thus described my invention, I claim:

1. A shoe drying frame comprising:
a frame having a face side and an opposing underside;
said frame having a first side wall and an opposing second side wall;
said frame having a front wall connecting said first side wall to said second side wall;
said frame having a rear wall connecting said first side wall to said second side wall;
said first side wall, second side wall, front wall and rear wall are connected to one another so as to form an opening sized for the acceptance of at least one athletic shoe;
at least one strap having a first end and a second end;
said at least one strap first end is secured to said first side wall;
said at least one strap second end is secured to said second side wall; and at least one securing means for securing said frame underside to a dryer drum.

2. The shoe drying frame of claim 1 wherein:
said at least one means for securing said frame underside to a dryer drum is a magnet.

3. The shoe drying frame of claim 1 wherein:
said at least one strap is elastic.

4. The shoe drying frame of claim 2 wherein:
said at least one strap is elastic.

5. The shoe drying frame of claim 1 wherein:
said at least one strap is adjustable.

6. The shoe drying frame of claim 5 wherein:
said at least one adjustable strap is secured to said first side wall at said first end;
said at least one adjustable strap extends through said second side wall at said second end; and
said at least one adjustable strap second end has a means for adjusting.

7. The shoe drying frame of claim 6 further comprising:
said means for adjusting is a clip.

8. The shoe drying frame of claim 5 wherein:
said at least one adjustable strap extends through said first side wall at said first end;
said at least one adjustable strap extends through said second side wall at said second end; and
said at least one adjustable strap second end has a means for adjusting.

9. The shoe drying frame of claim 8 further comprising:
said means for adjusting is a clip.

10. The shoe drying frame of claim 1 wherein:
said at least one strap is removable.

11. The shoe drying frame of claim 10 wherein:
said at least one removable strap attached to said first side wall and to said second side wall via hook and loop type fastening material.

12. The shoe drying frame of claim 5 wherein:
said at least one strap is removable.

13. A shoe drying frame comprising:
a frame having a face side and an opposing underside;
said frame having a first side wall and an opposing second side wall;
said frame having a front wall connecting said first side wall to said second side wall;
said frame having a rear wall connecting said first side wall to said second side wall;
said first side wall, second side wall, front wall and rear wall are connected to one another so as to form an opening sized for the acceptance of at least one shoe;
at least one adjustable strap having a first end and a second end;
said at least one adjustable strap first end is secured to said first side wall;
said at least one adjustable strap second end extends through said second side wall;
said at least one adjustable strap second end has a means for adjusting; and
at least one securing means for securing said frame underside to a dryer drum.

14. The shoe drying frame of claim 13 wherein:
said at least one adjustable strap is elastic.

15. The shoe drying frame of claim 13 wherein:
said means for adjusting said at least one adjustable strap is a clip.

16. The shoe drying frame of claim 15 wherein:
said at least one means for securing said frame underside to a dryer drum is at least one magnet.

17. A shoe drying frame comprising:
a frame having a face side and an opposing underside;
said frame having a first side wall and an opposing second side wall;
said frame having a front wall connecting said first side wall to said second side wall;
said frame having a rear wall connecting said first side wall to said second side wall;
said first side wall, second side wall, front wall and rear wall are connected to one another so as to form an opening sized for the acceptance of at least one shoe;
at least one removable strap having a first end and a second end;
said at least one removable strap first end is removably connected to said first side wall;
said at least one removable strap second end is removably connected to second side wall;
a means for removably connecting said at least one removable strap to said side walls; and
at least one securing means for securing said frame underside to a dryer drum.

18. The shoe drying frame of claim 17 wherein:
said at least one means for securing said frame underside to a dryer drum is a magnet.

19. The shoe drying tray of claim 17 wherein:
said means for removably connecting said at least one removable strap to said side walls is hook and loop type fastening material on each end of the at least one removable strap and the side walls.

20. The shoe drying tray of claim 1 further comprising:
at least one adjustment buckle located on said at least one strap.
